(19) United States
(12) Patent Application Publication
(10) Pub. No.: US 2022/0371331 A1
(43) Pub. Date: Nov. 24, 2022

(54) APPARATUS HAVING SUCTION VALVES

(71) Applicant: Hewlett-Packard Development Company, L.P., Spring, TX (US)

(72) Inventors: Lynn A. Collie, Vancouver, WA (US); Kevin Ken Kuramura, Vancouver, WA (US); Kevin Lo, Vancouver, WA (US)

(21) Appl. No.: 17/771,962

(22) PCT Filed: Nov. 1, 2019
(86) PCT No.: PCT/US19/59323

§ 371 Date: Apr. 26, 2022

(51) Int. Cl. B41J 2/175

(52) U.S. Cl. CPC B41J 2/17596

(57) ABSTRACT

In some examples, an apparatus can include a fluidic interconnect to interface with a print material supply cartridge, a suction valve in a normally closed position, and a supply inlet connected to the fluidic interconnect, where the suction valve is to actuate to an open position to allow fluidic transmission therebetween when the print material supply cartridge is interfaced with the apparatus.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is a section view of an example of an apparatus having suction valves consistent with the disclosure.

FIG. 2 is a section view of an example of a system having a magnetic suction valve consistent with the disclosure.

FIG. 3 is a section view of an example of a system having a magnetic suction valve consistent with the disclosure.

FIG. 4 is a section view of an example of a system having a vacuum chamber suction valve consistent with the disclosure.

FIG. 5 is a section view of an example of a system having a vacuum chamber suction valve consistent with the disclosure.

### DETAILED DESCRIPTION

Imaging devices may include a supply of a print material located in a print material supply cartridge. As used herein, the term “print material” refers to a substance which can be transported through and/or utilized by an imaging device. In some examples, print material can be, for instance, a material that when applied to a medium, can form representation(s) (e.g., text, images models, etc.) on the medium during a print job. In some examples, print material can be, for instance, cleaning fluids, fluids for chemical analysis, fluids to be included during transportation of the imaging device (e.g., shipping to a customer), etc.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like.

The print material supply cartridge including the print material may interface with the imaging device and include a supply of the print material such that the print material may be drawn from the print material supply cartridge as the imaging device creates the representations on the print medium. As used herein, the term “print material supply cartridge” refers to a container, a tank, and/or a similar vessel to store a supply of the print material for use by the imaging device. In some examples, the print material supply cartridge can provide print material directly to a print head of the imaging device. In some examples, the print material supply cartridge can supply print material to a print material reservoir which can provide print material to a print head of the imaging device.

As the print material is provided to the imaging device via the print material supply cartridge (e.g., directly to a print head or to a reservoir), the amount of print material in the print material supply cartridge may deplete. As a result, the amount of print material in a print material supply cartridge or a print material reservoir of the imaging device may have to be replenished.

A print material supply cartridge may be filled, replaced, etc. In some examples, the print material supply cartridge may supply print material to a reservoir and be removed. In some examples, the print material supply cartridge may be interfaced with the imaging device and reside in the imaging device to provide print material when appropriate. The valve system may include a suction valve that can be meant to be opened when the print material supply cartridge is attached to the imaging device.

In some instances, the valve may not be used for extended periods of time. For example, print material may be provided to a reservoir of an imaging device and may not be replenished for an extended period of time as the imaging device may include a large print material reservoir, the imaging device may not perform many print jobs, etc. Print material may be left upstream of the valve (e.g., in a fluidic interconnect and/or in a supply inlet to the valve) as a result. In such an instance, this print material may dry out, which can inhibit and/or prevent valve function, may be transported into the imaging device, etc., which may cause damage to the valve and/or imaging device.

An apparatus having suction valves, according to the disclosure, can allow for print material to be provided to an imaging device via a suction valve by actuating the suction valve when a print material supply cartridge is received by the apparatus. Further, when no print material supply cartridge is present, the suction valve may be actuated passively by a pump, which can transport print material which may be located upstream of the valve to prevent such print material from drying out.

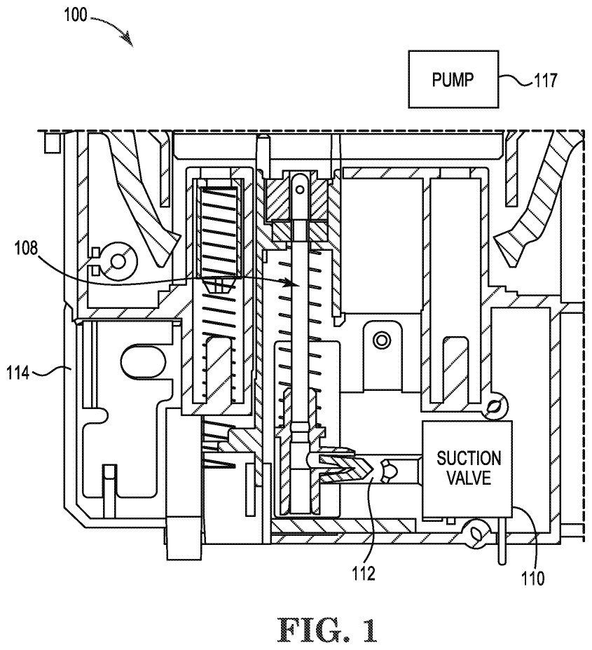

FIG. 1 is a section view of an example of an apparatus 100 having suction valves consistent with the disclosure. The apparatus 100 can include a fluidic interconnect 108, a suction valve 110, a supply inlet 112, a bezel 114, and a pump 117.

The apparatus 100 can include a fluidic interconnect 108. As used herein, the term “fluidic interconnect” refers to a device oriented to interface with a print material supply cartridge and transmit print material to a supply inlet. In some examples, the fluidic interconnect 108 can include a needle, where the needle can interface with a print material supply cartridge. In some examples, the fluidic interconnect 108 can receive a needle included with a print material supply cartridge. The fluidic interconnect 108 can be utilized to transport print material to and/or from the print material supply cartridge, as is further described herein.

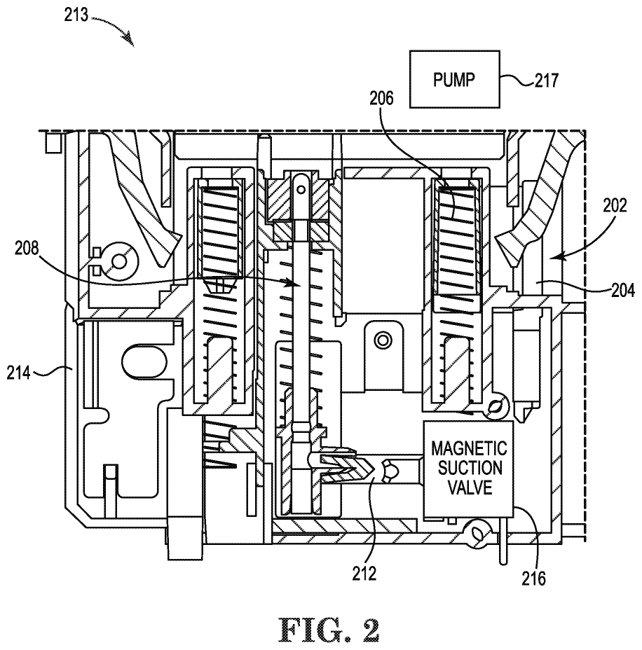

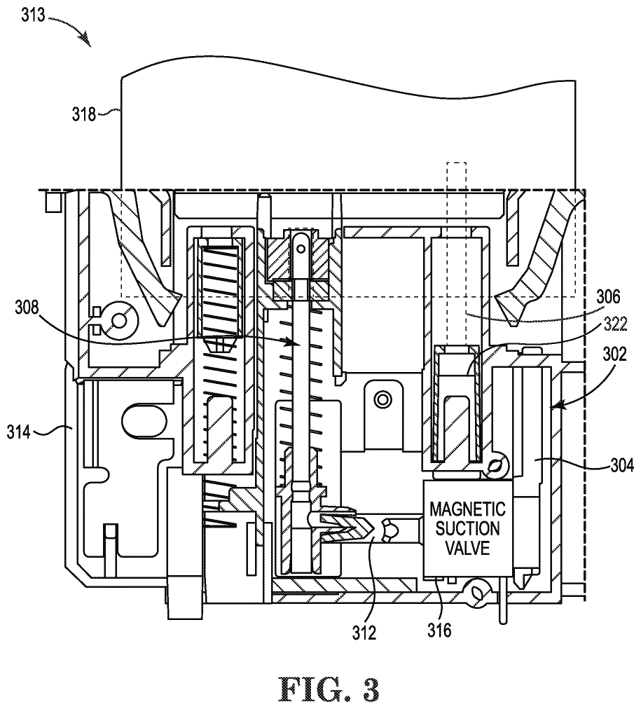

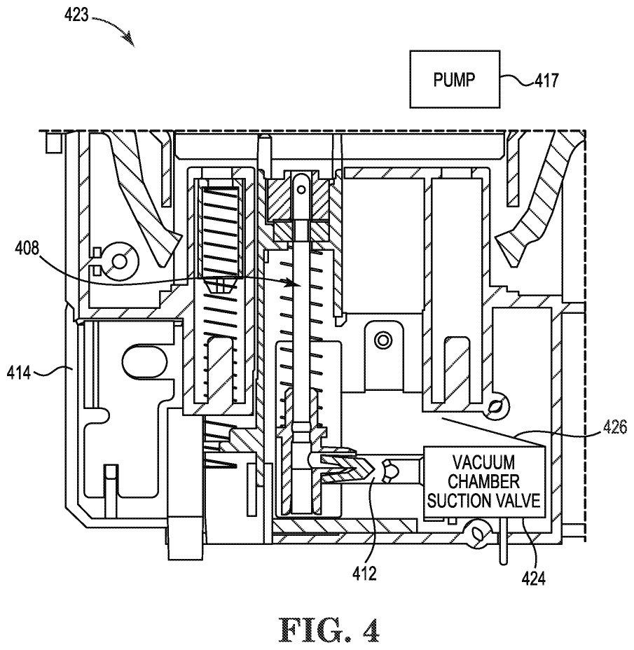

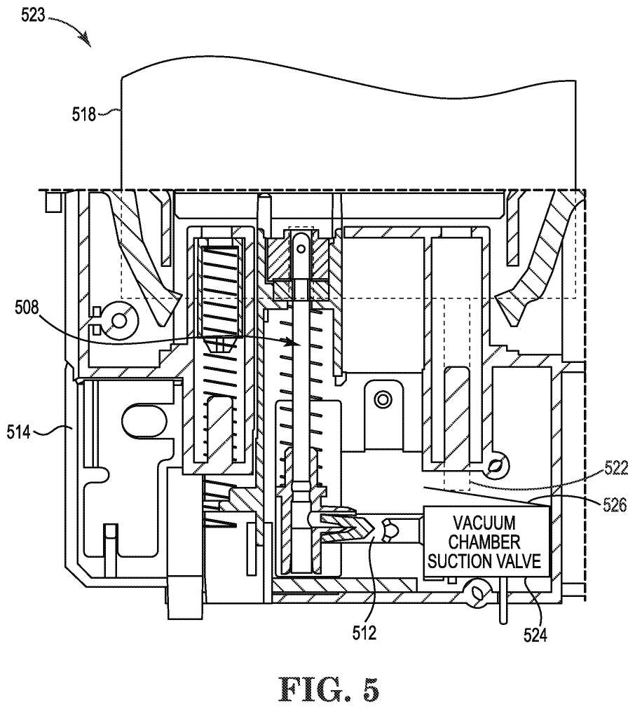

The apparatus 100 can include a suction valve 110. As used herein, the term “suction valve” refers to a device that regulates the flow of a fluid by opening, closing, or partially obstructing a passageway. The suction valve 110 can be actuated by suction (e.g., as is further described herein), magnetically (e.g., as is further described in connection with FIGS. 2 and 3), mechanically (e.g., as is further described in connection with FIGS. 4 and 5).

The suction valve 110 can be in a normally closed position. As used herein, the term “normally closed” refers to a position of a valve which prevents the flow of a fluid by being closed until acted upon by an external input. For example, the suction valve 110 can be normally closed unless actuated by suction, magnetically, and/or mechanically.

The apparatus 100 can include a supply inlet 112. As used herein, the term “supply inlet” refers to a passage along which something moves. For example, the supply inlet 112 can be a passage along which print material can be fluidically transmitted from the fluidic interconnect 108 into and through the suction valve 110 when the suction valve 110 is in an open position to supply print material to an imaging device.

The apparatus 100 can include a bezel 114. As used herein, the term “bezel” refers to a structural component of a system to which other components of the system are attached. For example, the bezel 114 can be a structural component of the apparatus 100. The fluidic interconnect 108, suction valve 110, the supply inlet 112, and/or other components of the apparatus 100 may be attached to the bezel 114.

The suction valve 110 can be actuated in various ways. For instance, in some examples the suction valve 110 can be actuated by a plunger moving from a first position to a second position (e.g., as is further described in connection with FIG. 3). The plunger can move from the first position to the second position in response to a print material supply cartridge being interfaced with the bezel 114 of the apparatus 100. For example, a key of the print material supply cartridge can contact the plunger and cause the plunger to move from the first position to the second position and compress a spring as the print material supply cartridge is interfaced with the bezel 114 of the apparatus 100. Actuation of the suction valve 110 in response to a plunger being moved from a first position to a second position can allow fluidic transmission of print material between the fluidic interconnect 108 and the suction valve 110.

In some examples, the suction valve 110 can be actuated by a key of a print material supply cartridge (e.g., as is further described in connection with FIG. 5). For example, when a print material supply cartridge is interfaced with the bezel 114, a key of the print material supply cartridge can depress a lever of the suction valve 110. Actuation of the suction valve 110 in response to a key depressing a lever of the suction valve 110 allow fluidic transmission of print material between the fluidic interconnect 108 and the suction valve 110.

Print material can be transmitted from the print material supply cartridge to a print material reservoir via the supply inlet 112 and the suction valve 110 in response to the print material cartridge being interfaced with the bezel 114. For example, the print material supply cartridge can provide print material to a print material reservoir of an imaging device via the fluidic interconnect 108, where the print material can be transmitted through the fluidic interconnect 108, the supply inlet 112, and the suction valve 110 to be provided to the imaging device for use (e.g., to a print material reservoir for storage, to a print head of the imaging device, for cleaning, for chemical analysis, for transportation purposes, etc.).

Print material can be transmitted from a print material supply reservoir to the print material supply cartridge via the suction valve 110 and the supply inlet 112 in response to the print material cartridge being interfaced with the bezel 114. For example, in some instances print material included in the imaging device (e.g., in a print material supply reservoir) may be transmitted back into a print material supply cartridge. In such an instance, the print material reservoir of the imaging device can supply the print material supply cartridge with print material via the suction valve 110, the supply inlet 112, and the fluidic interconnect 108 (e.g., and into the print material supply cartridge).

As described above, print material can be transmitted from a print material supply cartridge to a print material reservoir and/or transmitted from the print material reservoir to the print material supply cartridge via the fluidic interconnect 108, supply inlet 112, and suction valve 110. Accordingly, the suction valve 110 can function as a two-way valve depending on a specified direction of print material transmission (e.g., from a print material cartridge to a print material reservoir of an imaging device and/or from the print material reservoir of the imaging device to a print material cartridge).

When the print material supply cartridge is removed from the bezel 114, the suction valve 110 can actuate from the open position back to the normally closed position, preventing fluidic transmission of print material between the fluidic interconnect 108 and the suction valve 110.

As described above, the suction valve 110 can be actuated by a plunger or by a key of a print material supply cartridge. However, examples of the disclosure are not so limited. For example, the suction valve 110 can be actuated by a pump, as is further described herein.

The apparatus 100 can include a pump 117. As used herein, the term “pump” refers to a device that moves a fluid by mechanical action. For example, the pump 117 can create suction to cause the suction valve 110 to be actuated from the normally closed position to an open position. The open position can allow print material to be transmitted through the suction valve 110, as is further described herein.

In some examples, print material may be located in the fluidic interconnect 108 and/or in the supply inlet 112. For instance, after a print material supply cartridge is removed from the bezel 114, an amount of print material may be left over in the fluidic interconnect 108 and/or in the supply inlet 112. Print material located in such areas may dry out. Dried print material can cause such passages (e.g., the fluidic interconnect 108 and/or the supply inlet 112) to be blocked, can inhibit proper functioning of the suction valve 110, and/or may be transported into the imaging device which can damage other parts of the imaging device. In such an example in which print material may be located in the fluidic interconnect 108 and/or in the supply inlet 112 and there is no print material supply cartridge interfaced with the bezel 114, the pump 117 can create suction (e.g., low pressure) to cause the suction valve 110 to be actuated to an open position. Actuation of the suction valve 110 by suction created by the pump 117 can allow for fluidic transmission of print material (e.g., located in the fluidic interconnect 108 and/or in the supply inlet 112) between the fluidic interconnect 108 and the suction valve 110. Allowing for fluidic transmission of such print material can prevent the print material from being left in the fluidic interconnect 108 and/or in the supply inlet 112 and drying out.

FIG. 2 is a section view of an example of a system 213 having a magnetic suction valve 216 consistent with the disclosure. The system 213 can include a plunger assembly 202, a fluidic interconnect 208, a magnetic suction valve 216, a supply inlet 212, and a pump 217. The plunger assembly 202 can include a plunger 204 and a spring 206.

The system 213 can include a plunger assembly 202 including a plunger 204 and a spring 206. As used herein, the term “plunger assembly” refers to a collection of devices oriented such that a plunger is translated when an acted upon by another device. For example, the plunger assembly 202 can include a plunger 204 and a spring 206. As used herein, the term “plunger” refers to a structure that is translatable in response to an applied force. For example, the plunger 204 can translate up and/or down (e.g., as oriented in FIG. 2) in response to a force on the plunger (e.g., by a key and/or by a spring 206).

As oriented in FIG. 2, the plunger 204 can be in a first position. The first position can be a position of the plunger 204 at which the plunger 204 is not causing the magnetic suction valve 216 to be actuated from normally closed to open, as is further described herein.

As described above, the plunger assembly 202 can include a spring 206, As used herein, the term “spring” refers to a mechanical device that stores energy. For example, the spring 206 can be a coil spring.

The spring 206 can be oriented in order to bias the plunger 204 in the first position (e.g., as illustrated in FIG. 2). For example, the spring 206 can be in a resting position (e.g., spring 206 is not compressed) such that the plunger 204 is normally in the first position (e.g., the plunger 204 is not in the second position to actuate the magnetic suction valve 216, as is further described herein and in connection with FIG. 3).

As described above, the spring 206 can bias the plunger 204 in a first position (e.g., as oriented in FIG. 2). The system 213 can further include a fluidic interconnect 208 that can interface with a print material supply cartridge, as is further described in connection with FIG. 3, and a supply inlet 212 connecting the fluidic interconnect 208 with a magnetic suction valve 216. The plunger assembly 202, the fluidic interconnect 208, supply inlet 212, and the magnetic suction valve 216 can be attached to the bezel 214.

As illustrated in FIG. 2, the system 213 can include a magnetic suction valve 216. As used herein, the term “magnetic suction valve” refers to a device that regulates the flow of a fluid by opening, closing, or partially obstructing a passageway when actuated. In some examples, the magnetic suction valve 216 can regulate the flow of print material through the magnetic suction valve 216 by actuating the valve via the presence or absence of a magnetic field. The magnetic suction valve 216 can be in a normally closed position and can allow fluidic transmission of print material when in an open position, as is further described herein. In some examples, the magnetic suction valve 216 can be actuated by low pressure created by the pump 217, as is further described herein.

As illustrated in FIG. 2, the system 213 can include pump 217. The pump 217 can create suction to cause the magnetic suction valve 216 to be actuated from the normally closed position to an open position. The open position can allow print material to be transmitted through the magnetic suction valve 216, as is further described herein.

As illustrated in FIG. 2, the system 213 does not include a print material supply cartridge. In other words, the system 213 is illustrated in FIG. 2 as not having a print material supply cartridge interfaced with the bezel 214. Accordingly, the plunger 204 is in the first position so as to not actuate the magnetic suction valve 216.

In some examples in which system 213 does not include a print material supply cartridge being interfaced with the bezel 214, print material may be located in the fluidic interconnect 208 and/or in the supply inlet 212. For instance, after a print material supply cartridge is removed from the bezel 214, an amount of print material may be left over in the fluidic interconnect 208 and/or in the supply inlet 212. In such an example, the pump 217 can create negative pressure so as to cause the magnetic suction valve 216 to actuate from the normally closed position to the open position.

Actuation of the magnetic suction valve 216 by negative pressure (e.g., suction) created by the pump 217 can allow for fluidic transmission of print material (e.g., located in the fluidic interconnect 208 and/or in the supply inlet 212) between the fluidic interconnect 208 and the magnetic suction valve 216. Fluidic transmission of such print material out of the fluidic interconnect 208 and/or the supply inlet 212, through the magnetic suction valve 216, and to a print material reservoir in the imaging device can prevent the print material from drying out in the fluidic interconnect 208 and/or the supply inlet 212.

FIG. 3 is a section view of an example of a system 313 having a magnetic suction valve 316 consistent with the disclosure. The system 313 can include a plunger assembly 302, a fluidic interconnect 308, a magnetic suction valve 316, a supply inlet 312, and a print material supply cartridge 318. The plunger assembly 302 can include a plunger 304 and a spring 306. The print material supply cartridge 318 can include a key 322.

Although not illustrated in FIG. 3, the fluidic interconnect 308 can include a needle. As used herein, the term “needle” refers to a hollow piece of material to convey a material. For example, when the print material supply cartridge 318 is interfaced with the bezel 314, the needle of the fluidic interconnect 308 can interface with the print material supply cartridge 318.

Although the fluidic interconnect 308 is described above as including a needle, examples of the disclosure are not so limited. For example, the print material supply cartridge 318 can include a needle that can interface with the fluidic interconnect 308.

The print material supply cartridge 318 can include a key 322. As used herein, the term “key” refers to a protruding member having a shape that, when made to contact a plunger, allows an action to occur. The action can be, for example, causing the plunger 304 to be depressed from the first position (e.g., as previously illustrated in FIG. 2) to the second position (e.g., as illustrated in FIG. 3). For example, in response to the print material supply cartridge 318 interfacing with the bezel 314, the key 322 can contact the plunger 304 causing the plunger 304 to depress from the first position to the second position. The shape of the key 322 can be such that the bezel 314 can receive the key 322 in order to allow the key 322 to depress the plunger 304.

As a result of the key 322 depressing the plunger 304 from the first position to the second position, the magnetic suction valve 316 can actuate from the normally closed position to an open position. For example, the plunger 304 being in the second position can cause the magnetic suction valve 316 to be actuated magnetically from the normally closed position to the open position. As a result of the magnetic suction valve 316 being in the open position, print material can be supplied from the print material cartridge 318 to a print material reservoir (e.g., not illustrated in FIG. 3) via the fluidic interconnect 308, the supply inlet 312, and the magnetic suction valve 316.

When the print material supply cartridge 318 is removed from the bezel 314, the plunger 304 can move from the second position back to the first position as a result of the spring 306 decompressing. Decompression of the spring 306 can cause the plunger 304 to move back to the first position. As the plunger 304 is moved back to the first position, the magnetic suction valve 316 can actuate from the open position back to the normally closed position, preventing further fluidic transmission of print material between the print material supply cartridge 318 and the magnetic suction valve 316.

Removal of the print material supply cartridge 318 may leave print material located in the fluidic interconnect 308 and/or the supply inlet 312 when the magnetic suction valve 316 is actuated to the normally closed position. Accordingly, a pump (e.g., pump 217, previously described in connection with FIG. 2) may create suction to cause the magnetic suction valve 316 to open in order to transmit print material located in the fluidic interconnect 308 and/or the supply inlet 312 through the magnetic suction valve 316, as previously described in connection with FIG. 2.

FIG. 4 is a section view of an example of a system 423 having a vacuum chamber suction valve 424 consistent with the disclosure. The system 423 can include a fluidic interconnect 408, a vacuum chamber suction valve 424, a supply inlet 412, and a pump 417. The vacuum chamber suction valve 424 can include a lever 426.

As previously described in connection with FIG. 1, the system 423 can include a fluidic interconnect 408 that can interface with a print material supply cartridge, as is further described in connection with FIG. 5, and a supply inlet 412 connecting the fluidic interconnect 408 with a vacuum chamber suction valve 424. The fluidic interconnect 408, supply inlet 412, and the vacuum chamber suction valve 424 can be attached to the bezel 414.

As illustrated in FIG. 4, the system 423 can include a vacuum chamber suction valve 424. As used herein, the term “vacuum chamber suction valve” refers to a device that regulates the flow of a fluid by opening, closing, or partially obstructing a passageway when actuated. For example, the vacuum chamber suction valve 424 can regulate the flow of print material from a print material cartridge through the vacuum chamber suction valve 424 by actuating the valve via a lever 426 (e.g., as is further described in connection with FIG. 5). The vacuum chamber suction valve 424 can be in a normally closed position and can allow fluidic transmission of print material when in an open position, as is further described herein. In some examples, the vacuum chamber suction valve 424 can be actuated by low pressure created by the pump 217, as is further described herein.

As illustrated in FIG. 4, the vacuum chamber suction valve 424 can include a lever 426. As used herein, the term “lever” refers to a piece of material that pivots about a point to cause another object to move. For example, the lever 426 can pivot when acted upon by the plunger 404 when the plunger 404 is depressed from the first position (e.g., as illustrated in FIG. 4) to a second position (e.g., as illustrated in FIG. 5). For instance, the print material supply cartridge can depress the lever 426 to cause the lever 426 to pivot to cause the vacuum chamber suction valve 424 to actuate, as is further described in connection with FIG. 5.

As illustrated in FIG. 4, the system 423 can include pump 417. The pump 417 can create suction to cause the vacuum chamber suction valve 424 to be actuated from the normally closed position to an open position. The open position can allow print material to be transmitted through the vacuum chamber suction valve 424, as is further described herein.

As illustrated in FIG. 4, the system 423 does not include a print material supply cartridge. In other words, the system 423 is illustrated in FIG. 4 as not having a print material supply cartridge interfaced with the bezel 414. Accordingly, the vacuum chamber suction valve 424 is not being actuated by a key of a print material supply cartridge.

In some examples in which system 423 does not include a print material supply cartridge being interfaced with the bezel 414, print material may be located in the fluidic interconnect 408 and/or in the supply inlet 412. For instance, after a print material supply cartridge is removed from the bezel 414, an amount of print material may be left over in the fluidic interconnect 408 and/or in the supply inlet 412. In such an example, the pump 417 can create negative pressure so as to cause the vacuum chamber suction valve 424 to actuate from the normally closed position to the open position.

Actuation of the vacuum chamber suction valve 424 by negative pressure (e.g., suction) created by the pump 417 can allow for fluidic transmission of print material (e.g., located in the fluidic interconnect 408 and/or in the supply inlet 412) between the fluidic interconnect 408 and the vacuum chamber suction valve 424. Fluidic transmission of such print material out of the fluidic interconnect 408 and/or the supply inlet 412, through the vacuum chamber suction valve 424, and to a print material reservoir in the imaging device can prevent the print material from drying out in the fluidic interconnect 408 and/or the supply inlet 412.

FIG. 5 is a section view of an example of a system 523 having a vacuum chamber suction valve 524 consistent with the disclosure. The system 523 can include a fluidic interconnect 508, a vacuum chamber suction valve 524, a supply inlet 512, and a print material supply cartridge 518. The print material supply cartridge 518 can include a member 522. The vacuum chamber suction valve 524 can include a lever 526.

As illustrated in FIG. 5, the system 523 can include a print material supply cartridge 518. The print material supply cartridge 518 can include a member 522. As used herein, the term “member” refers to a constituent piece of a body. For example, the member 522 can be a piece of the print material supply cartridge 518. In some examples, the member 522 can be integrally formed with the print material supply cartridge 518. For example, the member 522 can be molded, three-dimensionally (3D) printed, etc. In some examples, the member 522 can be attached to the print material supply cartridge 518. For example, the member 522 can be glued, attached with a fastener, etc.

When the print material supply cartridge 518 is interfaced with the bezel 514, the fluidic interconnect 508 can interface with the print material supply cartridge 518. Further, in response to the print material supply cartridge 518 interfacing with the bezel 514, the member 522 can contact the lever 526 to depress the lever, as is further described herein.

As a result of the member 522 depressing the lever 526, the vacuum chamber suction valve 524 can actuate from the normally closed position to an open position. For example, the member 522 can depress the lever 526 to cause the lever 526 to pivot to cause the vacuum chamber suction valve 524 to be actuated from the normally closed position to the open position. As a result of the vacuum chamber suction valve 524 being in the open position, print material can be supplied from the print material supply cartridge 518 to a print material reservoir (e.g., not illustrated in FIG. 5) via the fluidic interconnect 508, the supply inlet 512, and the vacuum chamber suction valve 524.

Although the lever 526 is described above as being depressed by a member 522 of the print material supply cartridge 518, examples of the disclosure are not so limited. For example, the member 522 can be a key (e.g., key 322, previously described in connection with FIG. 3).

When the print material supply cartridge 518 is removed from the bezel 514, the lever 526 pivot as a result of the member 522 being removed from the lever 526. As the lever 526 pivots back, the vacuum chamber suction valve 524 can actuate from the open position back to the normally closed position, preventing further fluidic transmission of print material between the print material supply cartridge 518 and the vacuum chamber suction valve 524.

Removal of the print material supply cartridge 518 may leave print material located in the fluidic interconnect 508 and/or the supply inlet 512 when the vacuum chamber suction valve 524 is actuated to the normally closed position. Accordingly, a pump (e.g., pump 417, previously described in connection with FIG. 4) may create suction to cause the vacuum chamber suction valve 524 to open in order to transmit print material located in the fluidic interconnect 508 and/or the supply inlet 512 through the vacuum chamber suction valve 524, as previously described in connection with FIG. 4.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 108 in FIG. 1 and an analogous element may be identified by reference numeral 208 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a fluidic interconnect to interface with a print material supply cartridge;
a suction valve in a normally closed position; and
a supply inlet connected to the fluidic interconnect, wherein the suction valve is to actuate to an open position to allow fluidic transmission therebetween when the print material supply cartridge is interfaced with the apparatus.

2. The apparatus of claim 1, wherein:
the suction valve is to be actuated in response to a plunger moving from a first position to a second position; and
actuation of the suction valve is to allow fluidic transmission of print material between the fluidic interconnect and the suction valve.

3. The apparatus of claim 1, wherein:
the suction valve is to be actuated in response to a key of the print material supply cartridge depressing a lever of the suction valve; and
actuation of the suction valve is to allow fluidic transmission of print material between the fluidic interconnect and the suction valve.

4. The apparatus of claim 1, wherein the suction valve is to be actuated by a pump.

5. The apparatus of claim 4, wherein actuation of the suction valve by the pump is to allow fluidic transmission of print material between the fluidic interconnect and the suction valve.

6. The apparatus of claim 1, wherein in response to the print material supply cartridge being interfaced with the apparatus, print material is to be transmitted from the print material supply cartridge to a print material reservoir via the supply inlet and the suction valve.

7. The apparatus of claim 1, wherein in response to the print material supply cartridge being interfaced with the apparatus, print material is to be transmitted from a print material reservoir to the print material supply cartridge via the supply inlet and the suction valve.

8. A system, comprising:
a bezel;
a plunger assembly including a plunger and a spring, wherein the spring is to bias the plunger in a first position;
a fluidic interconnect to interface with a print material supply cartridge;
a magnetic suction valve in a normally closed position; and
a supply inlet connected to the fluidic interconnect, wherein the magnetic suction valve is to allow fluidic transmission therebetween when the magnetic suction valve is in an open position.

9. The system of claim 8, wherein the system further includes the print material supply cartridge including a key.

10. The system of claim 9, wherein in response to the print material supply cartridge interfacing with the bezel:
the key is to depress the plunger from the first position to a second position to cause the magnetic suction valve to actuate from the normally closed position to the open position; and
the fluidic interconnect is to interface with the print material supply cartridge to supply print material to a print material reservoir via the supply inlet and the magnetic suction valve.

11. The system of claim 8, wherein:
the system further includes a pump; and
negative pressure created by the pump is to cause the magnetic suction valve to actuate from the normally closed position to the open position to transport print material located in at least one of the fluidic interconnect and supply inlet to a print material reservoir.

12. A system, comprising:
a bezel;
a fluidic interconnect to interface with a print material supply cartridge;
a vacuum chamber suction valve in a normally closed position; and
a supply inlet connected to the fluidic interconnect, wherein the vacuum chamber suction valve is to allow fluidic transmission therebetween when the vacuum chamber suction valve is in an open position.

13. The system of claim 12, wherein the system further includes:
the print material supply cartridge including a member; and
vacuum chamber suction valve includes a lever.

14. The system of claim 13, wherein in response to the print material supply cartridge interfacing with the bezel:
the member of the print material supply cartridge is to depress the lever to cause the vacuum chamber suction valve to actuate from the normally closed position to the open position; and
the fluidic interconnect is to interface with the print material supply cartridge to supply print material to a print material reservoir via the supply inlet and the vacuum chamber suction valve.

15. The system of claim 12, wherein:
the system further includes a pump; and
negative pressure created by the pump is to cause the vacuum chamber suction valve to actuate from the normally closed position to the open position to transport print material located in at least one of the fluidic interconnect and supply inlet to a print material reservoir.
